(19) United States
(12) Patent Application Publication
(10) Pub. No.: US 2025/0296374 A1
(43) Pub. Date: Sep. 25, 2025

(54) LIQUID EJECTION APPARATUS, HEAD UNIT, AND METHOD OF COUPLING HEAD UNIT

(71) Applicant: SEIKO EPSON CORPORATION, Tokyo (JP)

(72) Inventors: Kazuki YOSHIMURA, Matsumoto (JP); Naoki YAMAZAKI, Shiojiri (JP)

(21) Appl. No.: 19/083,553

(22) Filed: Mar. 19, 2025

(30) Foreign Application Priority Data
Mar. 21, 2024 (JP) 2024-045511

(51) Int. Cl. B41J 25/34; B41J 2/045; B41J 2/14; B41J 2/175

(52) U.S. Cl. CPC B41J 25/34; B41J 2/04548; B41J 2/04581; B41J 2/17523; B41J 2/14201; B41J 2002/14491

(57) ABSTRACT

A liquid ejection apparatus includes a carriage and a head unit, wherein the carriage includes a first carriage surface on which the head unit is mounted, a first connector, a second carriage surface provided with the first connector, and a first fixation mechanism, the head unit includes a drive board, a second connector, a liquid ejection head, and a second fixation the mechanism, first fixation mechanism and the second fixation mechanism fix the head unit in a normal direction of the first carriage surface, the first connector and the second connector are fitted to each other in a normal direction of the second carriage surface, and when viewed from a third direction perpendicular to the first direction and the second direction, the first connector and the second connector are located between the first fixation mechanism and the second fixation mechanism.

The present application is based on, and claims priority from JP Application Serial Number 2024-045511, filed Mar. 21, 2024, the disclosure of which is hereby incorporated by reference herein in its entirety.

### BACKGROUND

### 1. Technical Field

The present disclosure relates to a liquid ejection apparatus, a head unit, and a method of coupling a head unit.

### 2. Related Art

In recent years, there is a demand for high-speed high-definition printing in industrial printers. Therefore, as described in, for example, JP-A-2017-132185, printers, a in recent industrial there is adopted configuration in which a plurality of print heads is arranged to thereby cope with high-speed printing, and the print heads and drive circuits thereof are mounted on a carriage to thereby cope with high-definition printing. A head unit including such a plurality of print heads grows in size. For example, JP-A-2017-132185 discloses a configuration in which an electric connector is indirectly fitted without being directly fitted with a hand in order to simplify the attachment and detachment work and to improve reliability in attaching and detaching such a large-sized head unit.

JP-A-2017-132185 is an example of the related art.

However, unless the head unit and the carriage are sufficiently fixed to each other, fitting of the connector becomes insufficient as the carriage moves, and there is a possibility that a problem occurs in electrical coupling, or that the connector is damaged.

### SUMMARY

An aspect of a liquid ejection apparatus according to the present disclosure includes
a carriage,
a head unit which is mounted on the carriage and is configured to eject a liquid to a medium, and
a power supply circuit configured to supply power to the head unit, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

An aspect of a head unit according to the present disclosure is a head unit which is supplied with power from a power supply circuit, mounted on a carriage, and configured to eject a liquid to a medium, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit including
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage, wherein,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

An aspect of a method of coupling a head unit according to the present disclosure is a method of coupling a head unit, which is supplied with power from a power supply circuit and configured to eject a liquid to a medium, to a carriage, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism,
the method including
mounting the head unit on the carriage so that a surface provided with the liquid ejection head of the head unit and the first carriage surface are parallel to each other,
fitting the first connector and the second connector to each other while keeping a state in which the surface provided with the liquid ejection head and the first carriage surface are parallel to each other, and
operating the first fixation mechanism and the second fixation mechanism to fix the head unit to the carriage.

### BRIEF DESCRIPTION OF THE DRAWINGS

FIG. 1 is a diagram showing a schematic configuration of a liquid ejection apparatus.

FIG. 2 is a diagram showing an example of a functional configuration of the liquid ejection apparatus.

FIG. 3 is a diagram illustrating a schematic configuration of an ejection unit.

FIG. 4 is a perspective view of a head unit.

FIG. 5 is an external view of the head unit viewed from the −Y side.

FIG. 6 is an external view of the head unit viewed from the +Y side.

FIG. 7 is an external view of the head unit viewed from the −X side.

FIG. 8 is an external view of the head unit viewed from the +X side.

FIG. 9 is an external view of the head unit viewed from the −Z side.

FIG. 10 is an external view of the head unit viewed from the +Z side.

FIG. 11 is a diagram showing an internal structure of the head unit viewed from the −X side.

FIG. 12 is an external view of a carriage viewed from the −Y side.

FIG. 13 is an external view of the carriage viewed from the −X side.

FIG. 14 is an external view of the carriage viewed from the −Z side.

FIG. 15 is an external view of a connector viewed from the −Z side.

FIG. 16 is an external view of the connector viewed from the −X side.

FIG. 17 is an external view of the connector viewed from the −Y side.

FIG. 18 is a cross-sectional view of the connector viewed from the −Z side.

FIG. 19 is an external view of the carriage on which the head units are mounted, viewed from the −Y side.

FIG. 20 is an external view of the carriage on which the head units are mounted, viewed from the −X side.

FIG. 21 is a flowchart representing an example of a procedure of a method of coupling the head unit.

FIG. 22 is a diagram illustrating a state of step S1 in FIG. 21.

FIG. 23 is a diagram illustrating a state of step S2 in FIG. 21.

FIG. 24 is a diagram illustrating a state of step S3 in FIG. 21.

FIG. 25 is a diagram illustrating a state of step S4 in FIG. 21.

FIG. 26 is a diagram illustrating a state of step S5 in FIG. 21.

### DESCRIPTION OF EMBODIMENTS

A preferred embodiment of the present disclosure will hereinafter be described using the drawings. The drawings to be used are for the sake of convenience of explanation. Note that the embodiment described below do not unreasonably limit the content of the present disclosure set forth in the appended claims. Further, it is not necessarily true that all the configurations to be described below are essential elements of the present disclosure.

### 1. Overview of Liquid Ejection Apparatus

Hereinafter, description is presented exemplifying an inkjet printer which forms an image to a medium by a carriage, on which a plurality of head units for ejecting ink as an example of a liquid is mounted, moving in one direction, and the plurality of head units ejecting the ink to the medium at rest as an example of the liquid ejection apparatus according to the present disclosure. However, the liquid ejection apparatus according to the present embodiment is not limited to this, and may be an inkjet printer of, for example, a so-called serial printing type which forms an image to a medium to be conveyed by a carriage, on which a single head unit or a plurality of head units is mounted, reciprocating, and the single head unit or the plurality of head units ejecting the ink onto the medium to be transported to form an image on the medium. Alternatively, the liquid ejection apparatus according to the present embodiment may be an inkjet printer of a so-called line printing type which forms an image on a medium to be conveyed by a plurality of head units, which are arranged to have a length no smaller than the width of the medium, ejecting the ink onto the medium.

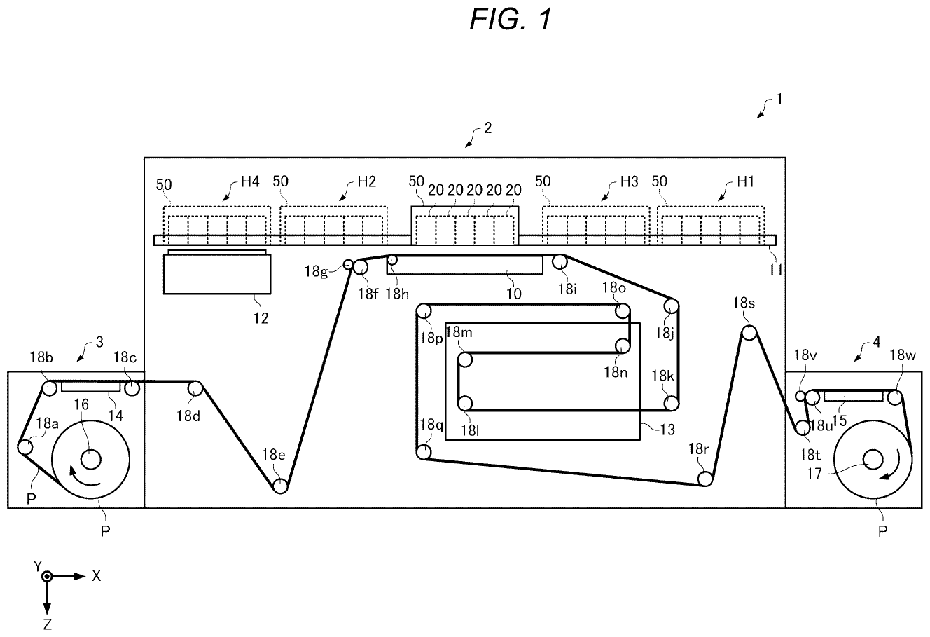

First, a schematic configuration of a liquid ejection apparatus 1 according to the present embodiment will be described. FIG. 1 is a diagram illustrating a schematic configuration of the liquid ejection apparatus 1 according to the present embodiment. In the following description, the description is presented defining a direction in which a carriage 50 moves as an X direction, a direction in which the ink is ejected as a Z direction, and a direction orthogonal to the X direction and the z direction as a Y direction. In FIG. 1, the X direction, the Y direction, and the Z direction are directions respectively represented by three arrows. Further, in some cases, a starting point side of the arrow representing the X direction may be referred to as a −X side, a tip side may be referred to as a +X side, a starting point side of the arrow representing the Y direction may be referred to as a −Y side, a tip side may be referred to as a +Y side, a starting point side of the arrow representing the Z direction may be referred to as a −Z side, and a tip side may be referred to as a +Z side. Note that the description will be presented assuming that the X direction, the Y direction, and the Z direction are directions orthogonal to each other, but the fact that a variety of constituents of the liquid ejection apparatus 1 are disposed so as to be orthogonal to each other is not a limitation. Further, as the medium P, there can be used any printing target such as printing paper, a resin film, or fabric.

As illustrated in FIG. 1, the liquid ejection apparatus 1 includes a main body unit 2 that performs print processing, a feeding unit 3 that feeds the medium P to the main body unit 2, and a winding unit 4 that winds the medium P discharged from the main body unit 2. The feeding unit 3 is disposed upstream (at the −X side) in the conveyance direction of the medium P with respect to the main body unit 2, and the winding unit 4 is disposed downstream (at the +X side) in the conveyance direction of the medium P.

In the feeding unit 3, the medium P wound to have a roll shape is rotatably supported by a winding shaft 16. The medium P fed from the roll is wound around a conveyance roller 18a and is conveyed to an upper surface of a feeding table 14 by a conveyance roller 18b. The medium P conveyed to the upper surface of the feeding table 14 is conveyed to the main body unit 2 by a conveyance roller 18c. Note that the feeding table 14 is used for cutting the medium P.

In the main body unit 2, the medium P is conveyed by conveyance rollers 18d, 18e, then pinched between a pair of conveyance rollers 18f, 18g, and then conveyed to an upper surface of a platen 10 by the conveyance roller 18h. Then, the ink is ejected from a plurality of head units 20 to the medium P conveyed to the upper surface of the platen 10, and thus an image is formed. A conveyance motor and an encoder (not shown) are coupled to the conveyance roller 18f.

The medium P on which the image has been formed on the upper surface of the platen 10 is conveyed to a drying chamber 13 by conveyance rollers 18i, 18j, and 18k. The medium P conveyed to the drying chamber 13 is conveyed inside the drying chamber 13 by conveyance rollers 18l, 18m, and 18n, and the medium P on which the image is formed is dried during the conveyance. Further, the medium P is discharged by a conveyance roller 180 from the drying chamber 13. The medium P discharged from the drying chamber 13 is conveyed by conveyance rollers 18p, 18q, 18r, and 18s to the winding unit 4.

In the winding unit 4, the medium P is wound around a conveyance roller 18t and is conveyed by a pair of conveyance rollers 18u, 18v to the upper surface of the winding table 15. The medium P conveyed to the upper surface of the winding table 15 is conveyed by a conveyance roller 18w, and is wound up to have a roll shape by the rotational drive of a winding drive shaft 17. The winding table 15 is used for cutting the medium P.

As shown in FIG. 1, the plurality of head units 20 is mounted on the carriage 50. The carriage 50 moves while being guided by a guide shaft 11 extending in the X direction due to an operation of a carriage motor (not shown). In FIG. 1, H1 is an initial position of the carriage 50. When the print processing is instructed, the carriage 50 moves from the position H1 to a position H2 and further moves from the position H2 to a position H3. While the carriage 50 moves from the position H2 to the position H3, the medium P as much as the length of one page is conveyed to the platen 10. Then, after the conveyance of the medium P stops, the carriage 50 moves from the position H3 to the position H2 and then stops. During a period in which the carriage 50 moves from the position H3 to the position H2, the ink is ejected from the plurality of head units 20, and an image is formed on the medium P located on the platen 10. The width in the Y direction of the plurality of head units 20 is substantially equal to the width in the Y direction of the medium P, and the image corresponding to the one page is formed on the medium P while the carriage 50 moves once from the position H3 to the position H2.

At a position H4, a lower surface of the carriage 50 is opposed to a maintenance unit 12. The maintenance unit 12 has a configuration including, for example, a cap member and a wiping member provided so as to correspond to each of the head units 20, and a suction device which is coupled to the cap member to suck the inside of the cap member. That is, when the carriage 50 is located at the position H1, automatic maintenance of the head units 20 is performed. In contrast, when the carriage 50 is located at the position H1, manual maintenance on the head units 20 can be performed. For example, the operator can perform wiping of a nozzle formation surface of the head unit 20, a replacement work of the head unit 20, and so on.

### 2. Functional Configuration of Liquid Ejection Apparatus

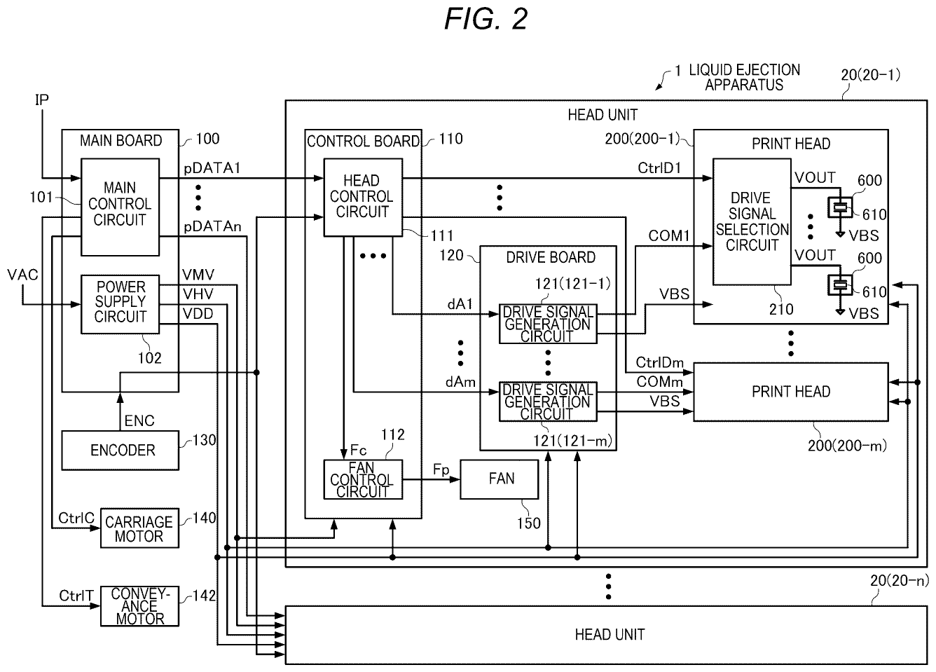

Then, a functional configuration of the liquid ejection apparatus 1 will be described. FIG. 2 is a diagram showing an example of the functional configuration of the liquid ejection apparatus 1. As shown in FIG. 2, the liquid ejection apparatus 1 includes a main board 100 and n head units 20. The character n is an integer no smaller than 1. Here, although the n head units 20 have substantially the same configurations, the n head units 20 may be referred to as head units 20-1 to 20-n in some cases when the n head units 20 are distinctly described. Further, the liquid ejection apparatus 1 includes an encoder 130, a carriage motor 140, and a conveyance motor 142. Although not shown in FIG. 1, the main board 100, the encoder 130, the carriage motor 140, and the conveyance motor 142 are provided to the main body unit 2.

As shown in FIG. 2, the main board 100 is provided with a main control circuit 101 and a power supply circuit 102.

Image data IP is input to the main control circuit 101 from a host computer (not shown). The main control circuit 101 generates print data pDATA1 to pDATAn of the respective head units 20-1 to 20-n based on the image data IP, and outputs the print data pDATA1 to pDATAn to the head units 20-1 to 20-n, respectively. Hereinafter, when the head units 20-1 to 20-n are referred to as the head units 20 without distinction, the print data pDATA1 to pDATAn are referred to as print data pDATA without distinction.

Further, The main control circuit 101 generates a control signal CtrlC for controlling the movement of the carriage 50, and outputs the control signal CtrlC to the carriage motor 140. The carriage motor 140 operates in accordance with the control signal CtrlC, and the movement of the carriage 50 is controlled by the carriage motor 140. Further, the main control circuit 101 generates a control signal CtrlT for controlling the conveyance of the medium P, and outputs the control signal CtrlT to the conveyance motor 142. The conveyance motor 142 operates in accordance with the control signal CtrlT, and at least a part of the conveyance rollers 18a to 18v is rotated or stopped by the conveyance motor 142, and thus, the conveyance of the medium P is controlled. Note that the control signal CtrlC may be input to the carriage motor 140 after being subjected to a signal conversion via a driver circuit (not shown), and the control signal CtrlT may similarly be input to the conveyance motor 142 after being subjected to a signal conversion via a driver circuit (not shown).

The power supply circuit 102 generates, from a commercial voltage VAC input from the outside of the liquid ejection apparatus 1, a power supply voltage VHV having a voltage value of, for example, 42V, a power supply voltage VMV having a voltage value of, for example, 24V, and a power supply voltage VDD having a voltage value of, for example, 3.3V, and outputs the power supply voltages to the head units 20-1 to 20-n in common. Note that the voltage value of the power supply voltage VHV, the voltage value of the power supply voltage VMV, and the voltage value of the power supply voltage VDD are not limited to 42V, 24V, and 3.3V, respectively.

A detection signal ENC of the encoder 130 is output to the head units 20-1 to 20-n in common via the main board 100. The detection signal ENC of the encoder 130 is used for identifying a position in the head units 20-1 to 20-n.

The head unit 20 includes a control board 110, a drive board 120, a fan 150, and m print heads 200. The character m is an integer no smaller than 1. Here, although the m print heads 200 have substantially the same configurations, when the m print heads 200 are distinctly described, the m print heads 200 may be referred to as print heads 200-1 to 200-m in some cases.

The control board 110 is provided with a head control circuit 111 and a fan control circuit 112. The control board 110 is supplied with the power supply voltages VDD, VMV, the head control circuit 111 operates based on the power supply voltage VDD, and the fan control circuit 112 operates based on the power supply voltages VDD, VMV.

The drive board 120 is provided with m drive signal generation circuits 121. The drive board 120 is supplied with the power supply voltages VDD, VHV, and the m drive signal generation circuits 121 operate based on the power supply voltages VDD, VHV. Here, although the m drive signal generation circuits 121 have substantially the same configurations, the m drive signal generation circuits 121 may be referred to as drive signal generation circuits 121-1 to 121-m in some cases when the m drive signal generation circuits 121 are distinctly described.

The print data pDATA and the detection signal ENC of the encoder 130 are input to the head control circuit 111. The head control circuit 111 figures out scanning positions of the respective print heads 200-1 to 200-m based on the detection signal ENC of the encoder 130. Further, the head control circuit 111 generates various control signals CtrlD1 to CtrlDm corresponding to the scanning positions of the print heads 200-1 to 200-m based on the print data pDATA and the scanning positions, and outputs the control signals CtrlD1 to CtrlDm to the print heads 200-1 to 200-m, respectively. Hereinafter, when the print heads 200-1 to 200-m are referred to as the print heads 200 without distinction, the control signals CtrlD1 to CtrlDm are also referred to as control signals CtrlD without distinction.

Further, the head control circuit 111 generates base drive signals dA1 to dAm for controlling the operation of the print heads 200-1 to 200-m, and outputs the base drive signals dA1 to dAm to the drive signal generation circuits 121-1 to 121-m, respectively. The base drive signals dA are digital signals including information defining signal waveforms of drive signals COM for driving piezoelectric elements 610 described later. Hereinafter, when the drive signal generation circuits 121-1 to 121-m are referred to as the drive signal generation circuits 121 without distinction, the base drive signals dA1 to dAm are also referred to as the base drive signals dA without distinction.

Further, the head control circuit 111 generates a control signal Fc for controlling the operation of the fan control circuit 112, and outputs the control signal Fc to the fan control circuit 112.

The fan control circuit 112 generates a control signal Fp based on the power supply voltage VMV and the control signal Fc, and outputs the control signal Fp to the fan 150.

The operation of the fan 150 is controlled by the control signal Fp. The fan 150 is disposed inside the head unit 20, and generates an airflow inside the head unit 20. The control board 110 and the drive board 120 are cooled by the airflow generated by the fan 150.

The drive signal generation circuits 121-1 to 121-m respectively convert the base drive signals dA1 to dAm into analog signals, and then, amplify the analog signal thus converted to thereby generate drive signals COM1 to COMm, respectively, and output the drive signals COM1 to COMm to the print heads 200-1 to 200m, respectively. That is, the base drive signals dA1 to dAm are digital signals including information defining the signal waveforms of the drive signals COM1 to COMm, respectively. Further, the drive signal generation circuits 121-1 to 121-m generate reference voltage signals VBS, and output the reference voltage signals VBS to the print heads 200-1 to 200m, respectively. The reference voltage signal VBS may be, for example, a ground potential having a voltage value of 0V or may be a DC voltage having a voltage value such as 5.5V or 6V.

The print head 200 operates based on the power supply voltages VDD, VHV. The print head 200 has a drive signal selection circuit 210 and a plurality of ejection units 600 including piezoelectric elements 610. The drive signal selection circuit 210 selects or deselects the signal waveforms provided to the drive signals COM based on the control signals CtrlD to thereby output drive signals VOUT corresponding to the plurality of ejection units 600, respectively. That is, when the print head 200 includes p ejection units 600, the drive signal selection circuit 210 generates p drive signals VOUT corresponding respectively to the p ejection units 600 and outputs the drive signals VOUT to the corresponding ejection units 600. As described above, the print heads 200-1 to 200-m select or deselect the signal waveforms provided to the drive signals COM1 to COMm based on the control signals CtrlD1 to CtrlDm, respectively, to thereby output the drive signals VOUT corresponding to the respective ejection units 600.

Each of the ejection units 600 includes the piezoelectric element 610. The drive signal VOUT corresponding to the piezoelectric element 610 is supplied to one end of the piezoelectric element 610. Further, the reference voltage signal VBS is commonly supplied to the other ends of the piezoelectric elements 610. Further, the piezoelectric element 610 is displaced due to a potential difference between the drive signal VOUT and the reference voltage signal VBS. A corresponding amount of ink to the displacement of the piezoelectric element 610 is ejected from the ejection unit 600 corresponding to the piezoelectric element 610. Then, when the ink ejected from the ejection unit 600 lands on the medium P, an image is formed on the medium P.

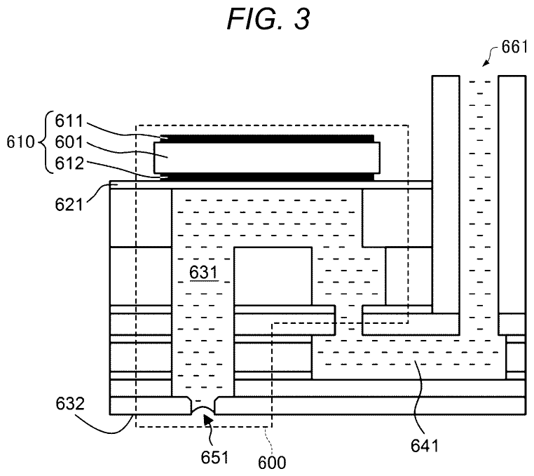

FIG. 3 is a diagram illustrating an example of a configuration of the ejection unit 600. FIG. 3 illustrates a nozzle plate 632, a reservoir 641, and a supply port 661 in addition to the ejection unit 600.

As illustrated in FIG. 3, the ejection unit 600 includes the piezoelectric element 610, a vibration plate 621, a cavity 631, and a nozzle 651. The piezoelectric element 610 includes a piezoelectric body 601 and electrodes 611 and 612. The piezoelectric element 610 is formed by the electrode 611, being 612 located across the piezoelectric body 601. Such a piezoelectric element 610 is driven so that a central portion is displaced in a vertical direction in accordance with a potential difference between a voltage supplied to the electrode 611 and a voltage supplied to the electrode 612. Specifically, the drive signal VOUT based on the drive signal COM is supplied to the electrode 611, and the reference voltage signal VBS is supplied to the electrode 612. Further, when the voltage value of the drive signal VOUT to be supplied to the electrode 611 changes, the potential difference between the drive signal VOUT supplied to the electrode 611 and the reference voltage signal VBS supplied to the electrode 612 changes, and the piezoelectric element 610 is driven so that a central portion is displaced in a vertical direction.

The vibration plate 621 is located below the piezoelectric element 610 in FIG. 3. In other words, the piezoelectric element 610 is formed on a surface of the vibration plate 621, the surface being located at an upper side in FIG. 3. Such a vibration plate 621 is displaced in the vertical direction due to the drive of the piezoelectric element 610 in the vertical direction.

The cavity 631 is located at a lower side of the vibration plate 621 in FIG. 3. The ink is supplied to the cavity 631 from the reservoir 641. Further, the ink stored in a liquid container (not shown) is introduced into the reservoir 641 via the supply port 661. That is, the inside of the cavity 631 is filled with the ink stored in the liquid container. The internal volume of such a cavity 631 expands or contracts due to the displacement in the vertical direction of the vibration plate 621. That is, the vibration plate 621 functions as a diaphragm that changes the internal volume of the cavity 631, and the cavity 631 functions as a pressure chamber the internal pressure of which changes due to the displacement in the vertical direction of the vibration plate 621.

The nozzle 651 is an opening provided to the nozzle plate 632 and communicates with the cavity 631. When the internal volume of the cavity 631 changes, the ink that fills the inside of the cavity 631 is ejected from the nozzle 651 in accordance with the change in the internal volume.

In the ejection unit 600 configured as described above, when the piezoelectric element 610 is driven to bend upward, the vibration plate 621 is displaced upward. Thus, the internal volume of the cavity 631 expands, and as a result, the ink stored in the reservoir 641 is drawn into the cavity 631. On the other hand, when the piezoelectric element 610 is driven to bend downward, the vibration plate 621 is displaced downward. Thus, the internal volume of the cavity 631 contracts, and as a result, a corresponding amount of ink to the degree of the contraction of the internal volume of the cavity 631 is ejected from the nozzle 651. That is, a corresponding amount of ink to the voltage value of the drive signal VOUT is ejected from each of the plurality of ejection units 600.

It should be noted that the structure of the piezoelectric element 610 is not limited to the structure shown in FIG. 3 as long as the piezoelectric element 610 is driven by being supplied with the drive signal VOUT corresponding to the drive signal COM, and can eject the ink from the nozzle 651 by being driven in that structure.

### 3. Structure of Head Unit

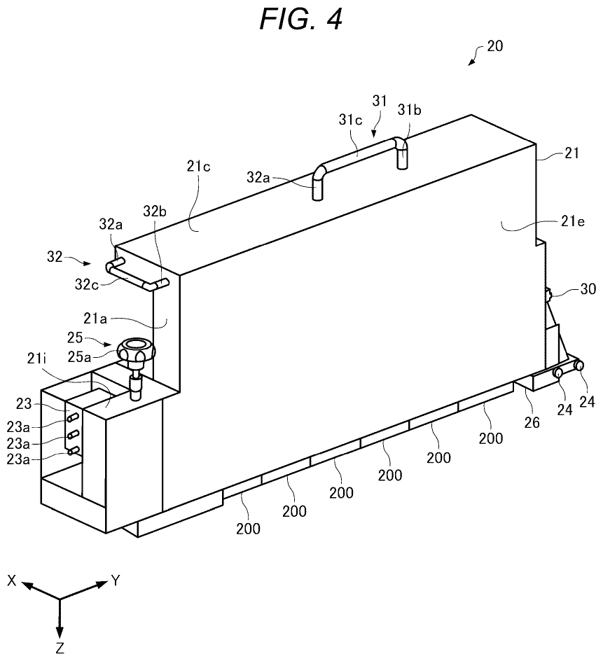

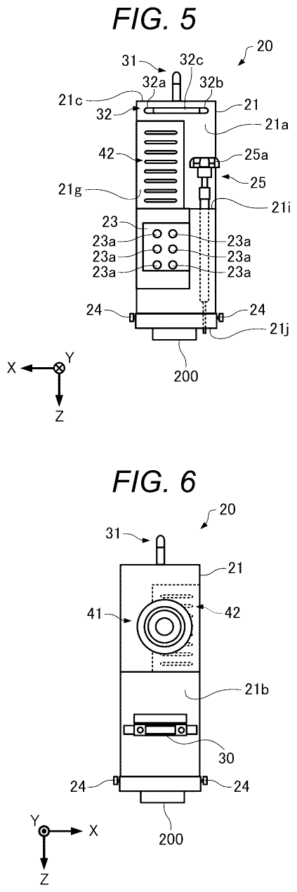

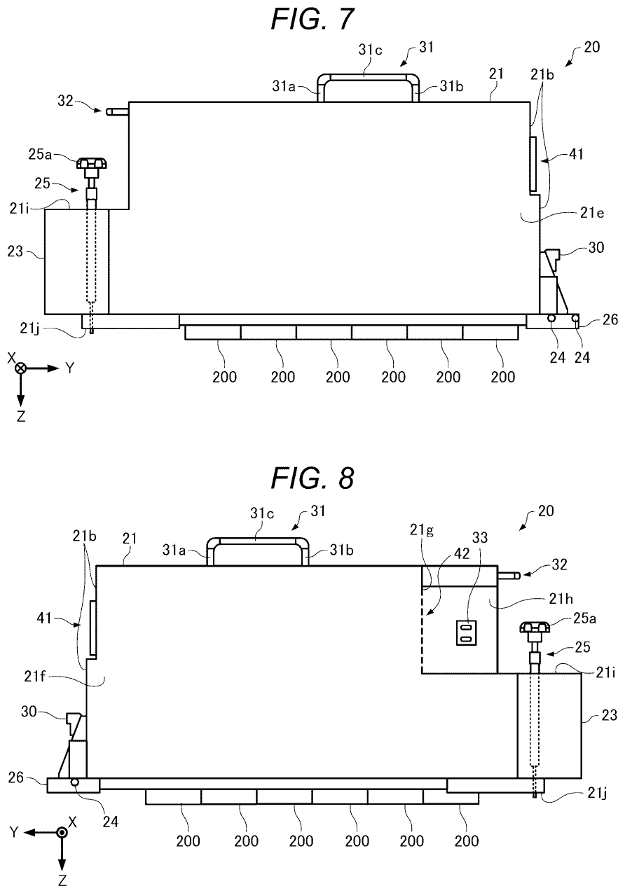

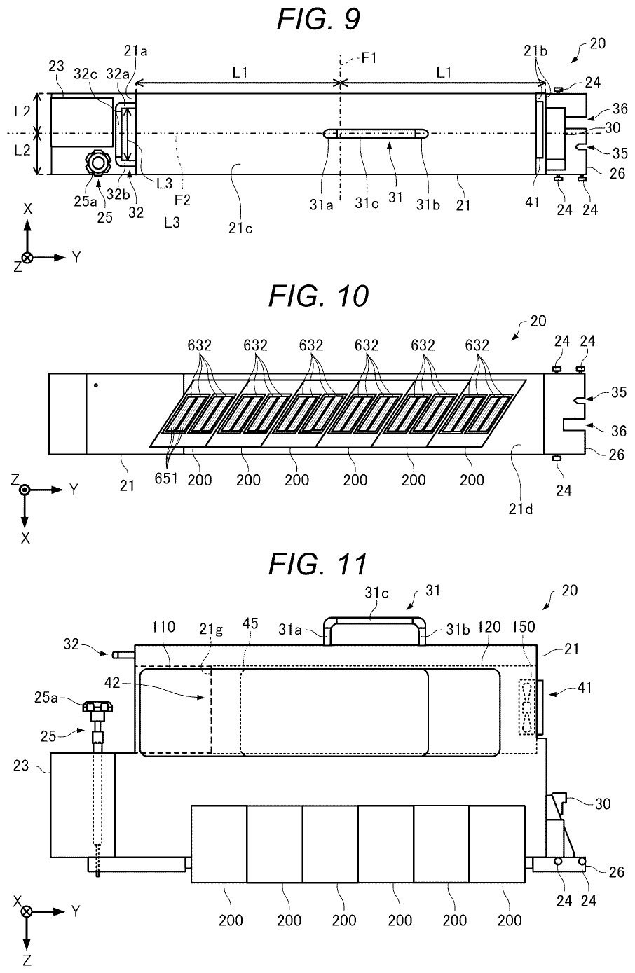

Then, the structure of the head unit 20 will be described with reference to FIGS. 4 to 11. FIG. 4 is a perspective diagram of the head unit 20. FIG. 5 is an external view of the head unit 20 viewed from the −Y side. FIG. 6 is an external view of the head unit 20 viewed from the +Y side. FIG. 7 is an external view of the head unit 20 viewed from the −X side. FIG. 8 is an external view of the head unit 20 viewed from the +X side. FIG. 9 is an external view of the head unit 20 viewed from the −Z side. FIG. 10 is an external view of the head unit 20 viewed from the +Z side.

As illustrated in FIGS. 4 to 10, the head unit 20 includes a housing 21 which houses the control board 110, the drive board 120, the fan 150, and the plurality of print heads 200. The housing 21 is made from metal and is formed of iron or the like, and has a weight no less than 5 kg. The housing 21 is a polygon having a shape approximate to a rectangular solid, and has surfaces 21a to 21f. The surface 21a and the surface 21b are surfaces opposite to each other, and are, for example, parallel to each other. The surface 21c and the surface 21d are surfaces opposite to each other, and are, for example, parallel to each other. The surface 21e and the surface 21f are surfaces opposite to each other, and are, for example, parallel to each other. Here, a concept that “two surfaces are parallel to each other” includes not only when an angle between the two surfaces is 0°, but also when the angle between the two surfaces slightly deviates from 0° due to manufacturing errors or the like. The surfaces 21a, 21b cross the surfaces 21c, 21d, 21e, and 21f, and are, for example, orthogonal to these surfaces. The surfaces 21c, 21d cross the surfaces 21a, 21b, 21e, and 21f, and are, for example, orthogonal to these surfaces. The surfaces 21e, 21f cross the surfaces 21a, 21b, 21c, and 21d, and are, for example, orthogonal to these surfaces. Here, a concept that “two surfaces are orthogonal to each other” includes not only when an angle between the two surfaces is 90°, but also when the angle between the two surfaces slightly deviates from 90° due to manufacturing errors or the like.

The surfaces 21c, 21d are longer in the Y direction than in the X direction, and the surfaces 21e, 21f are longer in the Y direction than in the Z direction. That is, the housing 21 is a polygon longer in the Y direction than in the X direction and the Z direction. When viewed from the operator who performs maintenance of the head unit 20, the surface 21a corresponds to a front surface of the housing 21, the surface 21b corresponds to a back surface of the housing 21, the surface 21c corresponds to an upper surface of the housing 21, the surface 21d corresponds to a lower surface of the housing 21, the surface 21e corresponds to a right side surface of the housing 21, and the surface 21f corresponds to a left side surface of the housing 21.

The head unit 20 further includes surfaces 21g, 21h. The surface 21g is a surface parallel to the surface 21a and is a surface located behind the surface 21a when the operator views the head unit 20 from the −Y side. That is, as shown in FIG. 5, when the head unit 20 is viewed from the −Y side, the surface 21g is also visually recognized together with the surface 21a. The surface 21h is a surface parallel to the surface 21c and is a surface located behind the surface 21f when the operator views the head unit 20 from the +X side. That is, as shown in FIG. 8, when the head unit 20 is viewed from the +X side, the surface 21h is also visually recognized together with the surface 21f.

As shown in FIG. 5, when the head unit 20 is viewed from the −Y side, the surface 21a of the housing 21 is visually recognized. That is, the normal direction of the surface 21a coincides with the Y direction. The surface 21a is provided with a tube coupling section 23 to be coupled to ink tubes as tubes for supplying the ink. The tube coupling section 23 is provided with a plurality of tube attachment ports 23a, and the plurality of ink tubes are coupled to the tube coupling section 23 by attaching a tip of the ink tube to each of the tube attachment ports 23a. The ink supplied from each of the ink tubes is supplied to each of the print heads 200. In the example in FIGS. 4 to 10, the head unit 20 has six print heads 200, and six tube attachment ports 23a are formed to the tube coupling section 23.

Further, a grip 32 is provided to the surface 21a. The grip 32 includes a support portion 32a, a support portion 32b, and a coupling portion 32c for coupling the support portion 32a and the support portion 32b to each other. In the grip 32, the support portions 32a, 32b are portions which are coupled to the surface 21a and are substantially perpendicular to the surface 21a, and the coupling portion 32c is a portion which couples the support portion 32a and the support portion 32b to each other, and is substantially parallel to the surface 21a. The grip 32 is made from metal and is formed of iron or the like. The grip 32 is provided to the surface 21a such that the coupling portion 32c extends along the X direction. For example, the grip 32 is provided to the surface 21a such that the coupling portion 32c is parallel to the X direction.

Further, a fixation mechanism 25 which extends in the Z direction so as to penetrate a hole provided to the surface 211 of the housing 21 at the −Y side of the surface 21a. The fixation mechanism 25 is a mechanism for fixing the head unit 20 to the carriage 50, and includes a handle 25a. When the operator rotates the handle 25a, the fixation mechanism 25 moves in the Z direction to penetrate a hole provided to the surface 21j of the housing 21 and a hole provided to the carriage 50, and the head unit 20 is fixed to the carriage 50. The fixation mechanism 25 is, for example, a screw.

As shown in FIG. 5, the surface 21g is provided with a vent 42. Since the surface 21g is a surface parallel to the surface 21a and is located at the +Y side of the surface 21a, the vent 42 is disposed at a position which can visually recognized when viewing the surface 21a from the Y direction. Note that the surface 21g may be formed to be coplanar with the surface 21a, and the surface 21a may be provided with the vent 42.

As shown in FIG. 6, when the head unit 20 is viewed from the +Y side, the surface 21b of the housing 21 is visually recognized. That is, the normal direction of the surface 21b coincides with the Y direction. The surface 21b is parallel to the surface 21a, and the direction from the surface 21a toward the surface 21b also coincides with the Y direction. The surface 21b is provided with a connector 30. The connector 30 is fitted into a connector 60 described later of the carriage 50, and power supply voltages VMV, VHV, and VDD and the detection signal ENC of the encoder 130 are supplied from the connector 60. The connector 30 supplies the power supply voltages VMV, VDD to the control board 110 via the connector 60, and supplies the power supply voltages VHV, VDD to the drive board 120 and the six print heads 200. Further, the connector 30 supplies the detection signal ENC of the encoder 130 to the control board 110 via the connector 60.

Further, the surface 21b is provided with a vent 41. Note that as shown in FIGS. 7, 8, and 9, the surface 21b is formed of two surfaces having a small gap therebetween, and the vent 41 is provided to the surface different from the surface provided with the connector 30. However, the connector 30 and the vent 41 may be provided to the surface 21b as a flat surface without a step.

As illustrated in FIG. 5, the shortest distance between the grip 32 and the surface 21c is shorter than the shortest distance between the tube coupling section 23 and the surface 21c, and is shorter than the shortest distance between the vent 42 and the surface 21c. That is, the grip 32 is disposed at a position close to the surface 21c. Specifically, the grip 32 is disposed in the uppermost portion of the surface 21a.

As shown in FIG. 7, when the head unit 20 is viewed from the −X side, the surface 21e of the housing 21 is visually recognized. That is, the normal direction of the surface 21e coincides with the X direction. Further, as shown in FIG. 8, when the head unit 20 is viewed from the +X side, the surface 21f of the housing 21 is visually recognized. That is, the normal direction of the surface 21f coincides with the X direction. The surface 21f is parallel to the surface 21e, and the direction from the surface 21e toward the surface 21f also coincides with the X direction. Two rollers 24 are disposed at the surface 21e side in a distal end portion 26 coupled to the housing 21 at the +Y side of the housing 21. Further, a single roller 24 is disposed at the surface 21f side in the distal end portion 26. The rollers 24 are provided to facilitate mounting of the head unit 20 on the carriage 50.

As shown in FIG. 8, a connector 33 is provided to the surface 21h. The connector 33 is, for example, a USB Type-C connector, and is coupled to a connector (not shown) provided to the main board 100 with a wiring cable. The connector 33 supplies the print data pDATA to the control board 110. Note that the surface 21h may be formed to be coplanar with the surface 21f, and the connector 33 may be provided to the surface 21f.

As shown in FIG. 9, when the head unit 20 is viewed from the −Z side, the surface 21c of the housing 21 is visually recognized. That is, the normal direction of the surface 21c coincides with the Z direction. The surface 21c is provided with a grip 31. The grip 31 includes a support portion 31a, a support portion 31b, and a coupling portion 31c for coupling the support portion 31a and the support portion 31b to each other. In the grip 31, the support portions 31a, 31b are portions which are coupled to the surface 21c and are substantially perpendicular to the surface 21c, and the coupling portion 31c is a portion which couples the support portion 31a and the support portion 31b to each other, and is substantially parallel to the surface 21c. The grip 31 is made from metal and is formed of iron or the like. The grip 31 is provided on the surface 21c such that the coupling portion 31c extends along the Y direction. That is, the grip 31 is provided to the surface 21c such that the coupling portion 31c extends along the longitudinal direction of the housing 21. For example, the grip 31 is provided to the surface 21c such that the coupling portion 31c is parallel to the Y direction which is the longitudinal direction of the housing 21. Since the liquid ejection apparatus 1 is a large printer, and the head unit 20 has a weight of 5 kg or more, the grip 31 is attached to the housing 21 with screws having a diameter of M4 or more so that the grip 31 is not detached when the operator grasps the grip 31 and lifts the head unit 20. In order to make it less likely to be detached, the grip 31 is preferably attached to the housing 21 with screws having a diameter of M5 or more.

As shown in FIG. 5, when viewed from the Y direction, the grip 31 and the grip 32 do not overlap each other. That is, since the grip 32 provided to the surface 21a does not protrude toward the surface 21c, when the operator grasps the grip 32 to push and pull the head unit 20, the force is efficiently transmitted to the surface 21a. Further, as shown in FIG. 9, when viewed from the Z direction, the grip 31 and the grip 32 do not overlap each other. That is, since the grip 31 provided on the surface 21c does not protrude toward the surface 21a, it is easy for the operator to grasp the grip 31 to lift the head unit 20 horizontally.

As illustrated in FIG. 9, the coupling portion 31c of the grip 31 crosses a first imaginary surface F1 located at an equal distance L1 from the surface 21b and the surface 21a. Further, the coupling portion 31c crosses the second imaginary surface F2 located at an equal distance L2 from the surface 21e and the surface 21f. That is, the grip 31 is disposed at a position approximate to the center of the surface 21c. In general, since the center position of the surface 21c which is the upper surface of the housing 21 is close to the centroid of the head unit 20, it is easy for the operator to grasp the grip 31 to lift the head unit 20 having the weight no less than 5 kg while keeping the head unit 20 horizontal in the X direction and the Y direction.

As illustrated in FIG. 9, the coupling portion 32c of the grip 32 crosses the second imaginary surface F2 located at the equal distance L2 from the surface 21e and the surface 21f. That is, the grip 32 is disposed so as to cross the center line in the X direction of the surface 21a of the head unit 20. Therefore, the operator can easily grasp the grip 32 to push and pull the head unit 20 in the Y direction while keeping the head unit 20 horizontal in the X direction.

Further, as shown in FIG. 5, the coupling portion 32c is disposed at the uppermost portion of the surface 21a. The length of the coupling portion 32c is 5 cm or more. That is, since a distance L3 between the support portion 32a and the support portion 32b is 5 cm or more, the operator can grasp the grip 32 with three or more fingers. Therefore, the operator can easily push and pull the head unit 20 having the weight no less than 5 kg in the Y direction gripping the grip 32. Further, the operator can easily lift the head unit 20 having the weight no less than 5 kg by gripping the grips 31, 32 with the left and right hands. The grip 32 is attached to the housing 21 with screws having a diameter of M4 or more so that the grip 32 does not detached when the operator grasps the grip 32 to lift the head unit 20 or to pull or push the head unit 20.

Further, as shown in FIG. 9, cutouts 35, 36 are provided in the distal end portion 26. The head unit 20 is fixed to the carriage 50 by the cutouts 35, 36 engaging with a fixation mechanism 55 (described later) of the carriage 50.

As shown in FIG. 10, when the head unit 20 is viewed from the +Z side, the surface 21d of the housing 21 is visually recognized. That is, the normal direction of the surface 21d coincides with the Z direction. The surface 21d is parallel to the surface 21c, and a direction from the surface 21c toward the surface 21d also coincides with the Z direction. The surface 21d is provided with the six print heads 200. As shown in FIGS. 7, 8, and 10, the six print heads 200 are arranged side by side in the Y direction. Note that the number of print heads 200 is not limited to six. As shown in FIG. 10, four nozzle plates 632 arranged in the Y direction are disposed on a lower surface which is a surface at the +Z side of the print head 200, and the plurality of nozzles 651 is arranged in each of the nozzle plates 632 in two rows in the Y direction. That is, two nozzle arrays are formed for each of the six print heads 200, and the four nozzle plates 632 arranged side by side in the Y direction are exposed from the surface 21d of the housing 21. Note that the number of nozzle plates 632 of the print head 200 is not limited to four.

FIG. 11 is a diagram showing an internal structure of the head unit 20 viewed from the −X side, and is a view of the head unit 20 in a state in which the surface 21e of the housing 21 is not present. As shown in FIG. 11, the control board 110, the drive board 120, and the fan 150 are housed inside the housing 21. Further, in each of the six head units 20, a part thereof including the nozzle plate 632 is exposed from the housing 21, and the rest thereof is housed inside the housing 21. Accordingly, the housing 21 functions as a protective member that protects the control board 110, the drive board 120, and the fan 150 from an impact or ink mist.

The control board 110, the drive board 120, and the fan 150 are disposed at positions closer to the surface 21c as an upper surface than to the surface 21d as a lower surface of the housing 21. Specifically, since the six print heads 200 are provided to the surface 21d, the control board 110, the drive board 120, and the fan 150 are disposed in a space between the six print heads 200 and the surface 21c.

Each of the control board 110 and the drive board 120 is provided so that the normal line of the mounting surface on which electronic components are mounted is aligned with the X direction. The drive board 120 is disposed at the +X side with respect to the control board 110, and when viewed from the X direction, the control board 110 and the drive board 120 partially overlap each other. The control board 110 is coupled to the connector 30 with a wiring cable or a wiring board (not shown), and the power supply voltages VMV, VHV, and VDD and the detection signal ENC of the encoder 130 are supplied from the connector 30. Further, the control board 110 is coupled to the connector 33 with a wiring cable or a wiring board (not shown), and the print data pDATA is supplied from the connector 33. The drive board 120 is coupled to the control board 110 with a BtoB connector (not shown) or the like, and the base drive signals dA and the power supply voltages VHV, VDD are supplied from the control board 110. BtoB an abbreviation for Board to Board. Each of the six print heads 200 is coupled to the control board 110 and the drive board 120 with a wiring board such as an FPC (not shown), the control signal CtrlD is supplied from the control board 110, and the drive signal COM and the reference voltage signal VBS are supplied from the drive board 120.

Further, a space 45 serving as a passage of a gas is disposed at the +X side of the drive board 120 with the vents 41, 42 at both ends. The control board 110 and the drive board 120 constitute a part of a wall surface of the space 45. The fan 150 is disposed in the space 45 so as to be adjacent to the vent 41. The fan 150 sucks the gas from one of the vents 41, 42 and discharges the gas from the other. For example, when the fan 150 is an intake fan, the vent 41 serves as an intake port, and the vent 42 serves as an exhaust port. Further, when the fan 150 is an exhaust fan, the vent 41 serves as the exhaust port, and the vent 42 serves as the intake port. As shown in FIG. 6, when viewed from the Y direction, at least a part of the vent 41 provided to the surface 21b and at least a part of the vent 42 provided to the surface 21g overlap each other. Therefore, since due to the airflow generated by the fan 150, the gas flows from one of the vents 41, 42 to the other in the space 45 without stagnating, the heat dissipation effect is enhanced, and the control board 110 and the drive board 120 are efficiently cooled.

### 4. Structure of Carriage

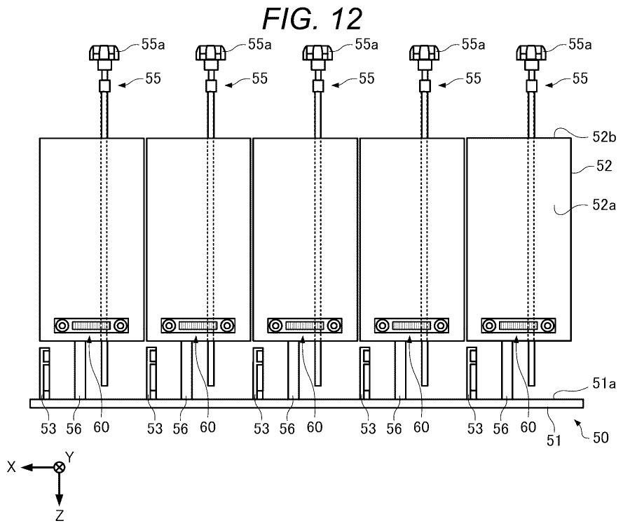

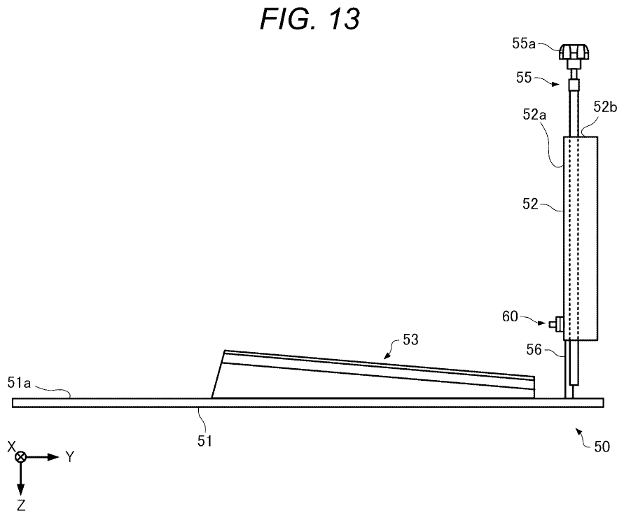

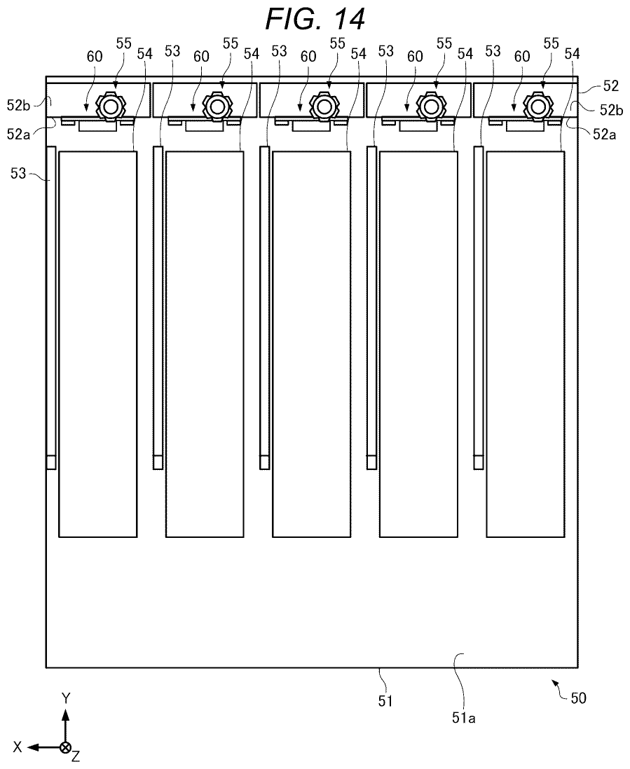

Then, the structure of the carriage 50 will be described with reference to FIGS. 12 to 18. FIG. 12 is an external view of the carriage 50 viewed from the −Y side. FIG. 13 is an external view of the carriage 50 viewed from the −X side. FIG. 14 is an external view of the carriage 50 viewed from the −Z side.

As shown in FIGS. 12 to 14, the carriage 50 includes a bottom plate 51 and a back plate 52. The bottom plate 51, the back plate 52, and rails 53 are made from metal and are formed of iron or the like.

As shown in FIG. 12, when the carriage 50 is viewed from the −Y side, a surface 52a of the back plate 52 is visually recognized. That is, the normal direction of the surface 52a coincides with the Y direction. Further, as shown in FIG. 14, when the carriage 50 is viewed from the −Z side, the surface 51a of the bottom plate 51 is visually recognized. That is, the normal direction of the surface 51a coincides with the Z direction. The surface 52a crosses the surface 51a and is, for example, orthogonal to the surface 51a. Note that since both the bottom plate 51 and the back plate 52 are constituents of the carriage 50, the surface 51a of the bottom plate 51 and the surface 52a of the back plate 52 are also the surfaces 51a, 52a of the carriage 50, respectively. Therefore, hereinafter, the surface 51a of the bottom plate 51 may be referred to as the surface 51a of the carriage 50, and the surface 52a of the back plate 52 may be referred to as the surface 52a of the carriage 50 in some cases.

As shown in FIGS. 12 to 14, the plurality of connectors 60 is disposed on the surface 52a of the carriage 50. The connectors 60 are coupled to a connector (not shown) provided to the main board 100 with a wiring cable. The power supply voltages VMV, VHV, and VDD output from the power supply circuit 102 propagate to the connectors 60 via the wiring cable. Further, the detection signal ENC of the encoder 130 propagates to the connectors 60 via the wiring cable. The connectors 60 are each fitted to the connector 30 of the head unit 20 to supply the power supply voltages VMV, VHV, and VDD and the detection signal ENC of the encoder 130 to the connector 30.

As shown in FIG. 14, a plurality of openings 54 is provided to the surface 51a of the carriage 50 so as to correspond to the plurality of connectors 60. The head unit 20 is mounted on the surface 51a of the carriage 50 in a state in which the exposed portions of the six print heads 200 are fitted into the opening 54. Further, the plurality of rails 53 is disposed on the surface 51a of the carriage 50 so as to correspond to the plurality of openings 54.

When the operator replaces the head unit 20 having the weight no less than 5 kg, a workload of the replacement is reduced by sliding the rollers 24 of the head unit 20 along the rail 53.

As shown in FIGS. 12 to 14, the carriage 50 is provided with a plurality of fixation mechanisms 55 extending in the Z direction so as to respectively penetrate a plurality of holes provided to the surface 52b of the back plate 52. The fixation mechanism 55 is a mechanism for fixing the head unit 20 to the carriage 50, and includes a handle 55a. When the operator rotates the handle 55a, the fixation mechanism 55 moves in the Z direction, and the tip portion of the fixation mechanism 55 is inserted through the cutout 35 provided to the head unit 20 and a hole provided to the surface 51a of the carriage 50, and the head unit 20 is fixed to the carriage 50. The fixation mechanism 55 is, for example, a screw.

As shown in FIGS. 12 and 13, the carriage 50 is provided with a plurality of guide portions 56 to be coupled to the bottom plate 51 and the back plate 52 so as to correspond to the plurality of connectors 60. The guide portion 56 has a function of engaging with the cutout 36 of the head unit 20 to support positioning of the head unit 20 and the fixation of the head unit 20 to the carriage 50.

In FIGS. 12 to 14, since there are five sets of the connector 60, the rail 53, the opening 54, the fixation mechanism 55, and the guide portion 56, the five head units 20 can be mounted on the carriage 50.

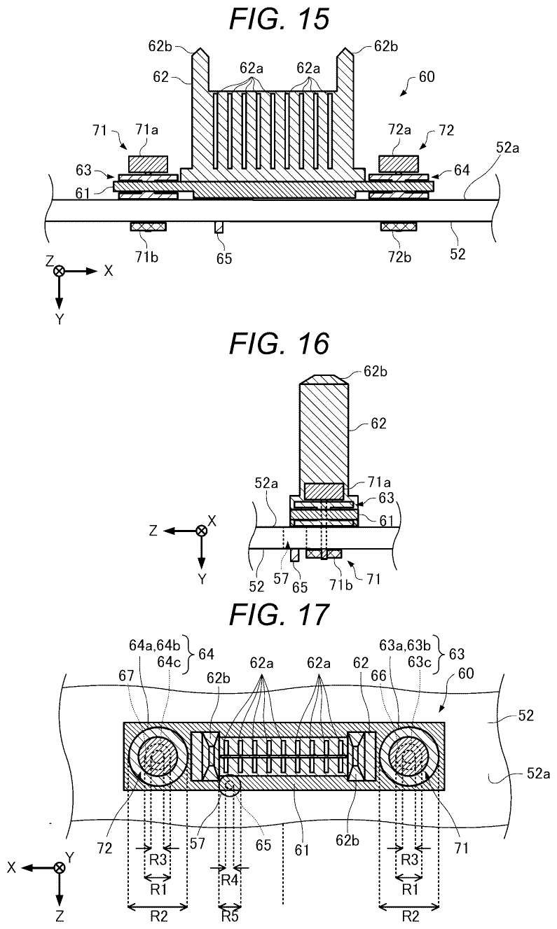

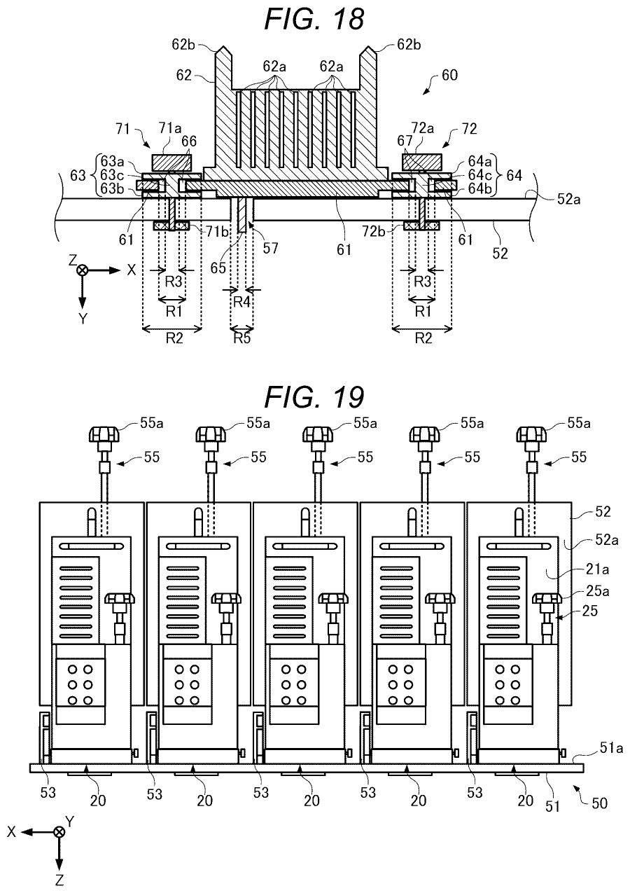

Then, a structure of the connector 60 will be described with reference to FIGS. 15 to 18. FIG. 15 is an external view of the connector 60 viewed from the −Z side. FIG. 16 is an external view of the connector 60 viewed from the −X side. FIG. 17 is an external view of the connector 60 viewed from the −Y side. FIG. 18 is a cross-sectional view of the connector 60 viewed from the −Z side.

As illustrated in FIGS. 15 to 18, the connector 60 includes a base portion 61, a coupling portion 62, a first holding portion 63, and a second holding portion 64.

As shown in FIGS. 17 and 18, the base portion 61 is provided with a first hole 66 and a second hole 67. As shown in FIGS. 15 to 18, the coupling portion 62 extends from the base portion 61, and is provided with a terminal group formed of a plurality of terminals 62a including terminals to which the power supply voltages VMV, VHV, and VDD and the detection signal ENC propagate, respectively. The coupling portion 62 includes a fitting portion 62b having a tapered shape. That is, the fitting portion 62b has a shape tapered toward the tip portion. The fitting portion 62b is a portion to be fitted to the connector 30 of the head unit 20, and the fitting portion 62b has the tapered shape, and has therefore a function of guiding the coupling between the connector 30 and the connector 60 to correct the position gap.

As shown in FIGS. 17 and 18, the first holding portion 63 includes a first portion 63a, a second portion 63b, and a third portion 63c which couples the first portion 63a and the second portion 63b to each other. That is, the first holding portion 63 has a so-called bobbin shape. As shown in FIG. 17, when viewed from the Y direction, the first portion 63a and the second portion 63b are larger in area than the first hole 66, and the third portion 63c is smaller in area than the first hole 66. Further, as illustrated in FIG. 18, when viewed from the Z direction, the first portion 63a and the second portion 63b do not overlap the first hole 66, and the third portion 63c overlaps the first hole 66. That is, the first portion 63a and the second portion 63b sandwich the first hole 66, and the third portion 63c is inserted through the first hole 66.

As shown in FIGS. 17 and 18, the second holding portion 64 includes a fourth portion 64a, a fifth portion 64b, and a sixth portion 64c which couples the fourth portion 64a and the fifth portion 64b to each other. That is, the second holding portion 64 has a so-called bobbin shape. As shown in FIG. 17, when viewed from the Y direction, the fourth portion 64a and the fifth portion 64b are larger in area than the second hole 67, and the sixth portion 64c is smaller in area than the second hole 67. Further, as shown in FIG. 18, when viewed from the Z direction, the fourth portion 64a and the fifth portion 64b do not overlap the second hole 67, and the sixth portion 64c overlaps the second hole 67. That is, the fourth portion 64a and the fifth portion 64b sandwich the second hole 67, and the sixth portion 64c is inserted through the second hole 67.

Here, as shown in FIG. 18, the length in the Y direction of the third portion 63c of the first holding portion 63 is larger than the thickness of the base portion 61 which is the length in the Y direction of the first hole 66. Similarly, the length in the Y direction of the sixth portion 64c of the second holding portion 64 is larger than the thickness of the base portion 61 which is the length in the Y direction of the second hole 67. That is, in the Y direction, there are gaps between the first portion 63a of the first holding portion 63 and the base portion 61, between the second portion 63b of the first holding portion 63 and the base portion 61, between the fourth portion 64a of the second holding portion 64 and the base portion 61, and between the fifth portion 64b of the second holding portion 64 and the base portion 61.

Further, as shown in FIG. 17, when viewed from the Y direction, an outer edge of the first hole 66 is a circle having a first diameter R1, an outer edge of the first portion 63a is a circle having a second diameter R2 larger than the first diameter R1, an outer edge of the second portion 63b is a circle having the second diameter R2, and an outer edge of the third portion 63c is a circle having a third diameter R3 smaller than the first diameter R1. Similarly, when viewed from the Y direction, an outer edge of the second hole 67 is a circle having the first diameter R1, an outer edge of the fourth portion 64a is a circle having the second diameter R2, an outer edge of the fifth portion 64b is a circle having the second diameter R2, and an outer edge of the sixth portion 64c is a circle having the third diameter R3.

Further, when the center of the circle of the outer edge of the first hole 66 and the center of the circle of the outer edge of the third portion 63c coincide with each other, the center of the circle of the outer edge of the second hole 67 and the center of the circle of the outer edge of the sixth portion 64c coincide with each other. Therefore, the base portion 61 is movable in any directions in the X −Z plane within a range of a difference between the first diameter R1 and the third diameter R3, with respect to the first holding portion 63 and the second holding portion 64 fixed to the surface 52a of the carriage 50. In this way, the first holding portion 63 is inserted through the first hole 66 to hold the base portion 61 so as to be movable within a predetermined range. Similarly, the second holding portion 64 is inserted through the second hole 67 to hold the base portion 61 so as to be movable within a predetermined range. An upper limit of the predetermined range is a difference between the first diameter R1 and the third diameter R3.

Note that when viewed from the Y direction, the outer edges of the first portion 63a, the second portion 63b, and the third portion 63c of the first holding portion 63 are not limited to circles, and may be polygonal shapes such as hexagonal shapes. Similarly, when viewed from the Y direction, the outer edges of the fourth portion 64a, the fifth portion 64b, and the sixth portion 64c of the second holding portion 64 are not limited to circles, and may be polygonal shapes such as hexagonal shapes.

As illustrated in FIGS. 15 to 18, the carriage 50 includes first fixation members 71 and second fixation members 72 that fix the connectors 60 to the surface 52a of the carriage 50. The first fixation member 71 fixes the first holding portion 63 to the surface 52a of the carriage 50, and the second fixation member 72 fixes the second holding portion 64 to the surface 52a of the carriage 50. As shown in FIGS. 15 and 18, for example, the first fixation member 71 includes a first bolt 71a and a first nut 71b, and the second fixation member 72 includes a second bolt 72a and a second nut 72b. A screw hole (not shown) is provided to the first holding portion 63 at a position overlapping the center of the circle as the outer edge when viewed from the Y direction, and the first holding portion 63 is fixed to the surface 52a of the carriage 50 by the first bolt 71a being inserted through that screw hole, and further penetrating the back plate 52 to be fitted to the first nut 71b. Similarly, a screw hole (not shown) is provided to the second holding portion 64 at a position overlapping the center of the circle as the outer edge when viewed from the Y direction, and the second holding portion 64 is fixed to the surface 52a of the carriage 50 by the second bolt 72a being inserted through that screw hole, and further penetrating the back plate 52 to be fitted to the second nut 72b. Note that the first fixation member 71 and the second fixation member 72 are not limited to what is configured with a bolt and a nut, and may be any members that can fix the connector 60 to the surface 52a of the carriage 50.

As described above, in the connector 60, the coupling portion 62 provided with the terminal group can move relatively to the first holding portion 63 and the second holding portion 64 fixed to the surface 52a of the carriage 50 with the first fixation member 71 and the second fixation member 72 in a predetermined range together with the base portion 61. Specifically, the base portion 61 and the coupling portion 62 can move relatively to the first holding portion 63 and the second holding portion 64 by a gap between the third portion 63c and the first hole 66 and a gap between the sixth portion 64c and the second hole 67. Therefore, even when the position at which the connector 60 and the connector 30 provided to the head unit 20 are fitted is displaced within a predetermined range, the coupling portion 62 of the connector 60 can move to engage with the connector 30.

As shown in FIGS. 15 to 18, the connector 60 may include a guide portion 65. The guide portion 65 is inserted through a hole 57 provided to the back plate 52 of the carriage 50. As shown in FIG. 17, when viewed from the Y direction, an outer edge of the hole 57 is a circle having a fourth diameter R4, and an outer edge of the guide portion 65 is a circle having a fifth diameter R5 larger than the fourth diameter R4. Here, the difference between the fifth diameter R5 and the fourth diameter R4 is larger than the difference between the first diameter R1 and the third diameter R3. Further, when the center of the circle of the outer edge of the first hole 66 and the center of the circle of the outer edge of the third portion 63c coincide with each other, and the center of the circle of the outer edge of the second hole 67 and the center of the circle of the outer edge of the sixth portion 64c coincide with each other, the center of the circle of the outer edge of the hole 57 coincides with the center of the circle of the outer edge of the guide portion 65. Therefore, when the base portion 61 moves in a predetermined range, the guide portion 65 also moves accordingly, but since the difference between the fifth diameter R5 and the fourth diameter R4 is larger than the difference between the first diameter R1 and the third diameter R3, the guide portion 65 can move without making contact with the hole 57. That is, the guide portion 65 can move without restricting the movable range of the base portion 61. The guide portion 65 and the hole 57 have a function of positioning the connector 60 when fixing the connector 60 to the back plate 52 with the first fixation member 71 and the second fixation member 72. Further, even when the first fixation member 71 or the second fixation member 72 is detached, the guide portion 65 and the hole 57 function to maintain the connector 60 in an approximately horizontal state, and also have a function of preventing the head unit 20 from being largely inclined to be damaged.

### 5. Coupling Between Head Unit and Carriage

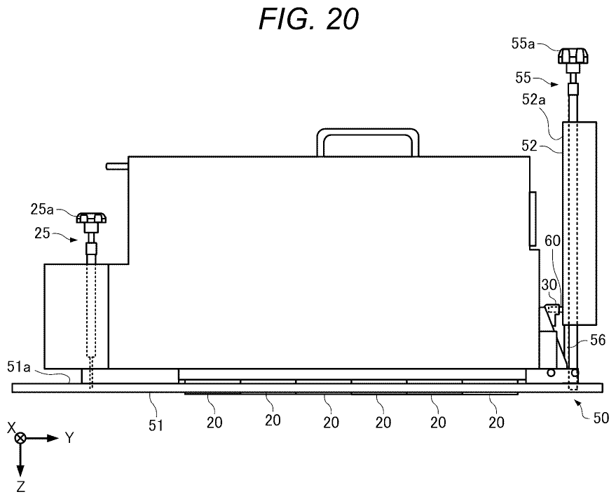

Then, a coupling structure between the head unit 20 and the carriage 50 will be described with reference to FIGS. 19 and 20. FIG. 19 is an external view of the carriage 50 on which the head units 20 are mounted viewed from the −Y side. FIG. 20 is an external view of the carriage 50 on which the head units 20 are mounted viewed from the −X side.

As shown in FIGS. 19 and 20, the head units 20 are fixed to the carriage 50 by the fixation mechanisms 55, 25. Since the weight of the head unit 20 is 5 kg or more, in order to prevent the head unit 20 from being damaged due to breakage of at least one of the fixation mechanisms 55, 25, relatively high strength is required for the fixation mechanisms 55, 25. Therefore, metals high in hardness such as iron, poly-oxy-benzyl-methylene-glycol-anhydride, or the like may be used as the materials of the fixation mechanisms 55, 25.

Meanwhile, resin is used as the material of the connector 30 of the head unit 20 and the connector 60 of the carriage 50. Therefore, the connector 30 and the connector 60 are low in strength and are easily broken. As shown in FIG. 20, since the connector 60 and the connector 30 are fitted to each other in the Y direction, when the operator supposedly fixes the head unit 20 to the carriage 50 in the Y direction, there is a possibility that the connector 30 or the connector 60 may be damaged by the stress applied to the connector 30 or the connector 60 when the crimping force for the fixation is excessive even slightly.

Therefore, in the present embodiment, as shown in FIGS. 19 and 20, when viewed from the X direction, the connector 60 and the connector 30 are located between the fixation mechanism 55 and the fixation mechanism 25, and the fixation mechanism 55 and the fixation mechanism 25 fix the head unit 20 in the Z direction. That is, the direction of the electrical coupling between the head unit 20 and the carriage 50 with the connectors 60, 30 and the direction of the mechanical coupling between the head unit 20 and the carriage 50 by the fixation mechanisms 55, 25 are made orthogonal to each other. As a result, even when the crimping force for fixing the head unit 20 is somewhat excessive, the stress applied to the connectors 60, 30 is not large, and therefore, the risk of damage to the connectors 60, 30 is reduced. Furthermore, in the connector 60, since the base portion 61 including the fitting portion 62b is movable within a predetermined range, the stress to be applied to the connectors 60, 30 is reduced, and the connectors 60, 30 are more difficult to be damaged.

Further, the Y direction, which is the direction of the electrical coupling between the head unit 20 and the carriage 50, and the Z direction, which is the direction of the mechanical coupling, are both orthogonal to the X direction in which the carriage 50 moves during printing. Therefore, since the direction of inertial force caused by the movement of the carriage 50 is orthogonal to the direction of the electrical coupling between the head unit 20 and the carriage 50 and the direction of the mechanical coupling therebetween, the possibility that these couplings are released or destabilized by the inertial force is low. Therefore, both the stability of the electrical coupling and the stability of the mechanical coupling are improved.

As shown in FIGS. 19 and 20, a part of the head unit 20 is located between the handle 55a of the fixation mechanism 55 and the surface 51a of the carriage 50, and another part of the head unit 20 is located between the handle 25a of the fixation mechanism 25 and the surface 51a of the carriage 50. That is, since the handles 55a, 25a are both located above the head unit 20, it is easy for the operator to operate the handles 55a, 25a, and the work for replacing the head unit 20 becomes easy. Further, as shown in FIGS. 19 and 20, the shortest distance between the handle 55a and the surface 52a of the carriage 50 is shorter than the shortest distance between the handle 25a and the surface 52a of the carriage 50, and the shortest distance between the handle 55a and the surface 51a of the carriage 50 is longer than the shortest distance between the handle 25a and the surface 51a of the carriage 50. That is, when viewed from the operator, since the handle 55a located at the back side is higher in position than the handle 25a located at the front side, it becomes easy for the operator to operate the handles 55a, 25a, and the work for replacing the head unit 20 becomes easy.

Further, since the tube coupling section 23 is provided to the surface 21a of the head unit 20, it results in that the tube coupling section 23 is located in front of the operator in the state in which the head unit 20 is fixed to the carriage 50 as shown in FIG. 19. Therefore, it becomes easy for the operator to perform the work of attaching an end of the ink tube to the tube attachment port 23a of the tube coupling section 23.

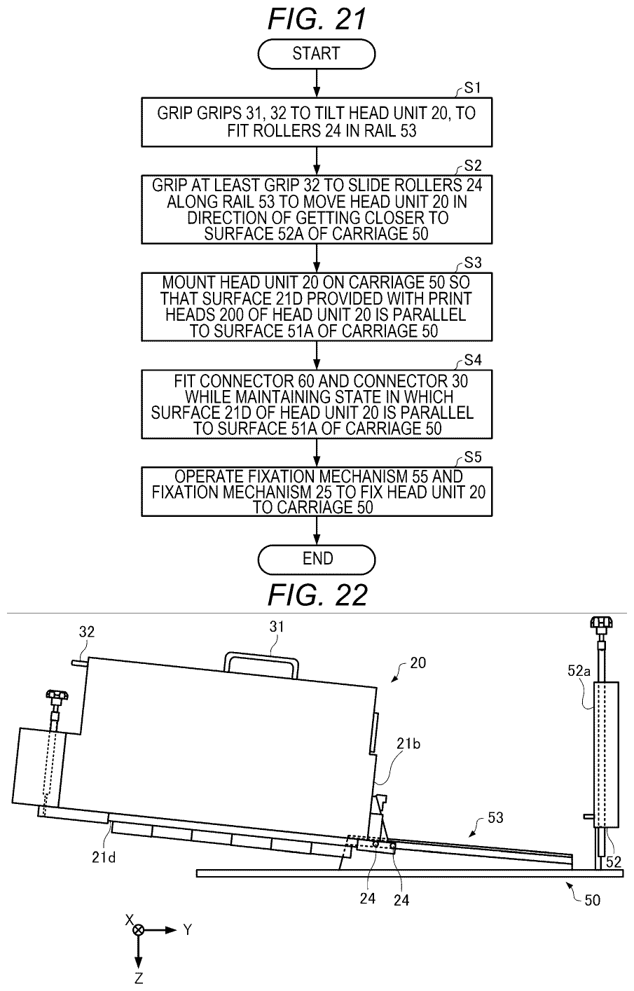

Then, a method of coupling the head unit 20 and the carriage 50 to each other will be described with reference to FIGS. 21 to 25. FIG. 21 is a flowchart representing an example of a procedure of the method of coupling the head unit for coupling the carriage 50 to the head units 20. FIGS. 22 to 25 are diagrams illustrating the state of respective steps in FIG. 21.

First, in step S1 in FIG. 21, as shown in FIG. 22, the operator grasps the grips 31, 32 and tilts the head unit 20 to fit the rollers 24 to the rail 53.

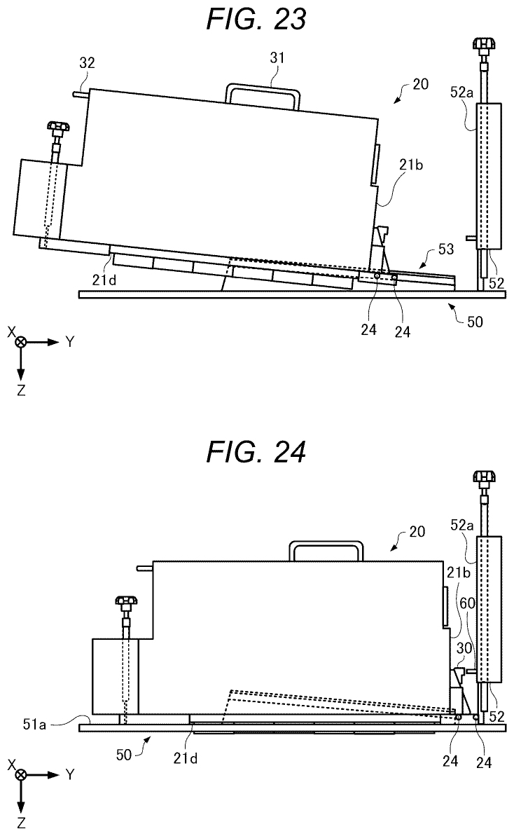

Then, in step S2, as shown in FIG. 23, the operator grips at least the grip 32 and slides the rollers 24 along the rail 53 to move the head unit 20 in a direction of getting closer to the surface 52a of the carriage 50. As described above, the grip 32 and the rollers 24 are used when the head unit 20 is moved in the direction of getting closer to the surface 52a of the carriage 50 and to be mounted on the carriage 50.

Then, in step S3, as shown in FIG. 24, the operator mounts the head unit 20 on the carriage 50 such that the surface 21d of the head unit 20 on which the print heads 200 are disposed is parallel to the surface 51a of the carriage 50.

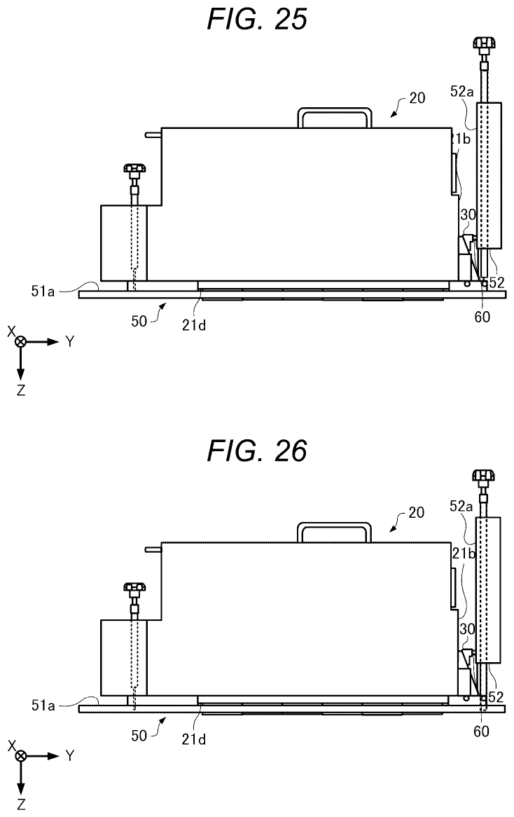

Then, in step S4, as shown in FIG. 25, the operator fits the connector 60 and the connector 30 to each other while maintaining a state in which the surface 21d of the head unit 20 and the surface 51a of the carriage 50 are parallel to each other.

Finally, in step S5, as shown in FIG. 26, the operator operates the fixation mechanism 55 and the fixation mechanism 25 to fix the head unit 20 to the carriage 50.

Note that in the present embodiment, the print head 200 is an example of a “liquid ejection head”. The Z direction is an example of a “first direction”, the Y direction is an example of a “second direction”, and the X direction is an example of a “third direction”. The surface 21b is an example of a “first surface”, and the surface 21a is an example of a “second surface”. The connector 60 is an example of a “first connector”, and the connector 30 is an example of a “second connector”. The surface 51a is an example of a “first carriage surface”, and the surface 52a is an example of a “second carriage surface”. The fixation mechanism 55 is an example of a “first fixation mechanism”, and the fixation mechanism 25 is an example of a “second fixation mechanism”.

### 6. Functions and Advantages

As described above, according to the liquid ejection apparatus 1 related to the present embodiment, since the grip 31 is provided to the surface 21c opposite to the surface 21d provided with the print heads 200 of the housing 21 so that the coupling portion 31c extends along the Y direction in the head unit 20, it is easy for the operator to grasp the grip 31 to lift the head unit 20 while keeping the head unit 20 horizontal. Further, since the grip 32 is provided to the surface 21a crossing the surface 21d provided with the print heads 200, it is easy for the operator to grasp the grip 32 to push and pull the head unit 20. Further, since the connector 30 is provided to the surface 21b opposite to the surface 21a provided with the grip 32 in the head unit 20, it is possible for the operator to grasp the grip 32 to press the head unit 20 thereinto to thereby fit the connector 30 to the connector 60 provided to the surface 52a of the carriage 50. Since the grip 32 is disposed such that the coupling portion 32c extends along the X direction at a position closer to the surface 21d than the tube coupling section 23 and the vent 42, it is easy for the operator to grasp the grips 31, 32 with both hands to lift the head unit 20, and further to grasp the grip 32 to fine-tune the tilt of the head unit 20 when pushing and pulling the head unit 20 along the rail 53. In particular, since the grip 31 provided to the surface 21c does not protrude toward the surface 21a, it is easy for the operator grasp the grip 31 to horizontally lift the head unit 20, and since the grip 32 provided to the surface 21a does not protrude toward the surface 21c, the force is efficiently transmitted to the surface 21a when the operator grasps the grip 32 to push and pull the head unit 20.

Further, according to the liquid ejection apparatus 1 related to the present embodiment, in the head unit 20, since the grip 31 is disposed at a position close to the center of the surface 21c, it is easy for the operator to grasp the grip 31 to lift the head unit 20 while keeping the head unit 20 horizontal. Further, since the grip 32 is disposed so as to cross the center line in the X direction of the surface 21a, it is easy for the operator to fine-tune the tilt of the head unit 20 so as to be aligned with the rail 53 while keeping the head unit 20 horizontal in the X direction. Further, since the operator can grasp the grip 32 with three or more fingers, even when the head unit 20 is heavy in weight, it is easy for the operator to tilt the head unit 20 so as to be aligned with the rail 53 to push and pull the head unit 20.

Therefore, according to the liquid ejection apparatus 1 related to the present embodiment, even when the weight of the head unit 20 is 5 kg or more, the possibility that the operator makes the print heads 200 collide with the surrounding objects to be damaged when lifting, pushing, or pulling the head unit 20 is reduced.

Further, according to the liquid ejection apparatus 1 related to the present embodiment, since the housing 21 is made from metal and is therefore high in strength, the possibility that the housing 21 is damaged by the stress applied when lifting, pushing, or pulling the head unit 20 is reduced. Further, since the grips 31, 32 are made from metal, and are therefore high in strength, a deformation and breakage of the grips 31, 32 less likely occur when lifting, pushing, or pulling the head unit 20. Further, since the grips 31, 32 are attached to the housing 21 with sufficient strength with the screws having the diameter of M4 or more, the possibility that the grips 31, 32 are detached from the housing 21 when the operator lifts, pushes, or pulls the head unit 20 is low. Accordingly, the possibility that the operator makes the print head 200 collide with the surrounding objects to be damaged when lifting, pushing, or pulling the head unit 20 is reduced.

Further, according to the liquid ejection apparatus 1 related to the present embodiment, the operator can press the head unit 20 into the carriage 50 with weak force by gripping the grip 32 to slide the roller 24 along the rail 53, and can therefore easily mount the head unit 20 on the carriage 50.

Further, according to the liquid ejection apparatus 1 related to the present embodiment, even when the position where the connector 60 provided to the surface 52a of the carriage 50 and the connector 30 provided to the surface 21b of the housing 21 of the head unit 20 are fitted to each other is shifted within a predetermined range, the coupling portion 62 of the connector 60 can move to fit to the connector 30. Further, the fitting portion 62b having the tapered shape provided to the coupling portion 62 of the connector 60 guides the engagement with the connector 30. Therefore, according to the liquid ejection apparatus 1 related to the present embodiment, it is easy to appropriately couple the connector 60 and the connector 30, and the possibility that the connector 60 or the connector 30 is damaged when fitting the connector 60 and the connector 30 to each other is reduced.

Further, according to the liquid ejection apparatus 1 related to the present embodiment, since the direction of the electrical coupling between the head unit 20 and the carriage 50 with the connectors 60, 30 and the direction of the mechanical coupling between the head unit 20 and the carriage 50 with the fixation mechanisms 55, 25 are orthogonal to each other, the stress applied to the connectors 60, 30 when fixing the head unit 20 is reduced, and the possibility that the connectors 60, 30 are damaged is reduced. Further, since the direction of inertial force caused by the movement of the carriage 50 is orthogonal to the direction of the electrical coupling between the head unit 20 and the carriage 50 and the direction of the mechanical coupling therebetween, the possibility that these couplings are released or destabilized by the inertial force is low. Therefore, the stability of both the electrical coupling and the mechanical coupling between the head unit 20 and the carriage 50 is improved.

Further, according to the liquid ejection apparatus 1 related to the present embodiment, since the handle 55a of the fixation mechanism 55 and the handle 25a of the fixation mechanism 25 are both located above the head unit 20, and the handle 55a located at the back side is higher in position than the handle 25a located at the front side when viewed from the operator, it is easy for the operator to operate the handles 55a, 25a, and the work of replacing the head unit 20 becomes easy.

According to the liquid ejection apparatus 1 related to the present embodiment, in the head unit 20, since the tube coupling section 23 is provided to the surface 21a provided with the grip 32, it is possible for the operator to manually couple the end of the ink tube to the tube coupling section 23 with ease in a state in which the connectors 60, 30 are fitted to each other, and the head unit 20 is fixed to the carriage 50 with the fixation mechanisms 55, 25.

### 7. Modified Examples

In the embodiment described above, in the housing 21 of the head unit 20, the surface 21a is provided with the tube coupling section 23 and the surface 21b is provided with the connector 30, but the surface 21a may be provided with the connector 30, and the surface 21b may be provided with the tube coupling section 23. In this case, a second tube coupling section to which the end of the ink tube is attached is provided to the surface 52a of the carriage 50, and the tube coupling section 23 provided to the surface 21b which is the back surface of the housing 21 is fitted to the second tube coupling section provided to the surface 52a of the carriage 50 by the operator gripping the grip 32 to press the head unit 20 into the carriage 50 along the rail 53. Meanwhile, the operator can manually fit the connector 60 coupled to the main board 100 with a wiring cable to the connector 30 provided to the surface 21a which is the front surface of the housing 21. Further, the connector 30 is provided to the surface 21a such that the shortest distance between the grip 32 provided on the surface 21a and the surface 21c of the housing 21 is shorter than the shortest distance between the connector 30 and the surface 21c and shorter than the shortest distance between the vent 42 and the surface 21c. That is, since the grip 32 is disposed at the position closer to the surface 21c than the connector 30 and the vent 42 so that the coupling portion 32c extends along the X direction, it is easy for the operator to grasp the grip 31 and the grip 32 with both hands to lift the head unit 20, and to grasp the grip 32 to fine-tune the tilt of the head unit 20. Accordingly, the possibility that the operator makes the print heads 200 collide with the surrounding objects to be damaged when lifting, pushing, or pulling the head unit 20 is reduced.

The present disclosure includes substantially the same configurations such as configurations having the same functions, methods, and results, and configurations having the same purposes and advantages as the configuration described in the present embodiment. Further, the present disclosure includes configurations obtained by replacing non-essential portions of the configurations described in the present embodiment. Furthermore, the present disclosure includes configurations that exert the same functions and advantages or configurations that can achieve the same objects as those of the configurations described in the present embodiment. Further, the present disclosure includes configurations obtained by adding a known technique to the configuration described in the present embodiment.

The embodiment the modified examples described above are illustrative only, and the present disclosure is not limited thereto. For example, the embodiment and the modified examples may appropriately be combined with each other.

The following contents is derived from the embodiment and the modified examples described above.

An aspect of a liquid ejection apparatus includes
a carriage,
a head unit which is mounted on the carriage and is configured to eject a liquid to a medium, and
a power supply circuit configured to supply power to the head unit, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

According to this liquid ejection apparatus, the head unit is fixed in the first direction perpendicular to the first carriage surface on which the head unit is mounted with the first fixation mechanism provided to the carriage and the second fixation mechanism provided to the head unit. Since the carriage moves in a direction parallel to the first carriage surface, the direction in which the head unit is fixed is perpendicular to the moving direction of the carriage. Therefore, since the direction of the inertial force caused by the movement of the carriage is orthogonal to the direction of the mechanical coupling of fixing the head unit to the carriage with the first fixation mechanism and the second fixation mechanism, the possibility that the mechanical coupling is released or destabilized by the inertial force is low. Therefore, according to this liquid ejection apparatus, it is easy to sufficiently fix the head unit to the carriage.

Further, according to this liquid ejection apparatus, the direction of the electrical coupling between the head unit and the carriage with the first connector and the second connector is orthogonal to the direction of the mechanical coupling between the head unit and the carriage with the first fixation mechanism and the second fixation mechanism. Accordingly, even when the crimping force for fixing the head unit becomes somewhat excessive, the stress applied to the first connector and the second connector is not large, and therefore, the possibility that the first connector or the second connector is damaged is reduced.

In one aspect of the liquid ejection apparatus,
the first fixation mechanism may include a first handle,
the second fixation mechanism may include a second handle,
a part of the head unit may be located between the first handle and the first carriage surface, and
another part of the head unit may be located between the second handle and the first carriage surface.

According to this liquid ejection apparatus, since the first handle of the first fixation mechanism and the second handle of the second fixation mechanism are both located above the head unit, it is easy for the operator to operate the first handle and the second handle, and the work of fixing the head unit to the carriage becomes easy.

In one aspect of the liquid ejection apparatus,
a shortest distance between the first handle and the first carriage surface may be shorter than a shortest distance between the second handle and the second carriage surface, and
a shortest distance between the first handle and the first carriage surface may be longer than a shortest distance between the second handle and the first carriage surface.

According to this liquid ejection apparatus, since the first handle which is located at the back side when viewed from the operator is located higher in position than the second handle, it is easy for the operator to operate the first handle and the second handle, and the work of fixing the head unit to the carriage becomes easy.

In one aspect of the liquid ejection apparatus,
the head unit may include
a tube coupling section to be coupled to a tube supplied with the liquid, and
a housing configured to house the drive board and provided with the second connector,
the housing may include
a first surface, and
a second surface opposite to the first surface,
the second connector may be provided to the first surface, and
the tube coupling section may be provided to the second surface.

According to the liquid ejection apparatus, since the tube coupling section is provided to the second surface opposite to the first surface provided with the second connector in the head unit, it is possible for the operator to couple the tube for supplying the liquid to the tube coupling section even in the state in which the first connector and the second connector are fitted to each other.

In one aspect of the liquid ejection apparatus,
the head unit may include
a grip to be used when the head unit is moved in a direction of getting closer to the second carriage surface to be mounted on the carriage.

According to this liquid ejection apparatus, the operator can grasp the grip to press the head unit into the carriage, and can therefore easily mount the head unit on the carriage.

In one aspect of the liquid ejection apparatus,
the head unit may include
a roller to be used when the head unit is moved in a direction of getting closer to the second carriage surface to be mounted on the carriage.

According to this liquid ejection apparatus, the operator can press the head unit into the carriage with weak force using the roller, and can therefore easily mount the head unit on the carriage.

An aspect of a head unit is a head unit which is supplied with power from a power supply circuit, mounted on a carriage, and configured to eject a liquid to a medium, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit including
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage, wherein,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

According to this head unit, since the direction of the inertial force caused by the movement of the carriage is orthogonal to the direction of the mechanical coupling of fixing the head unit to the carriage with the first fixation mechanism and the second fixation mechanism, the possibility that the mechanical coupling is released or destabilized by the inertial force is low. Therefore, according to this head unit, it is easy to sufficiently fix the head unit to the carriage.

Further, according to this head unit, the direction of the electrical coupling between the head unit and the carriage with the first connector and the second connector is orthogonal to the direction of the mechanical coupling between the head unit and the carriage with the first fixation mechanism and the second fixation mechanism. Accordingly, even when the crimping force for fixing the head unit becomes somewhat excessive, the stress applied to the first connector and the second connector is not large, and therefore, the possibility that the first connector or the second connector is damaged is reduced.

In one aspect of the head unit,
the first fixation mechanism may include a first handle,
the second fixation mechanism may include a second handle,
a part of the head unit may be located between the first handle and the first carriage surface, and
another part of the head unit may be located between the second handle and the first carriage surface.

In one aspect of the head unit,
a shortest distance between the first handle and the first carriage surface may be shorter than a shortest distance between the second handle and the second carriage surface, and
a shortest distance between the first handle and the first carriage surface may be longer than a shortest distance between the second handle and the first carriage surface.

One aspect of the head unit may include
a tube coupling section to be coupled to a tube supplied with the liquid, and
a housing configured to house the drive board and provided with the second connector, wherein
the housing may include
a first surface, and
a second surface opposite to the first surface,
the second connector may be provided to the first surface, and
the tube coupling section may be provided to the second surface.

One aspect of the head unit may include
a grip to be used when the head unit is moved in a direction of getting closer to the second carriage surface to be mounted on the carriage.

One aspect of the head unit may include
a roller to be used when the head unit is moved in a direction of getting closer to the second carriage surface to be mounted on the carriage.

An aspect of a method of coupling a head unit is a method of coupling a head unit, which is supplied with power from a power supply circuit and configured to eject a liquid to a medium, to a carriage, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism,
the method including
mounting the head unit on the carriage so that a surface provided with the liquid ejection head of the head unit and the first carriage surface are parallel to each other,
fitting the first connector and the second connector to each other while keeping a state in which the surface provided with the liquid ejection head and the first carriage surface are parallel to each other, and
operating the first fixation mechanism and the second fixation mechanism to fix the head unit to the carriage.

According to this method of coupling the head unit, since the direction of the inertial force caused by the movement of the carriage is orthogonal to the direction of the mechanical coupling of fixing the head unit to the carriage with the first fixation mechanism and the second fixation mechanism, the possibility that the mechanical coupling is released or destabilized by the inertial force is low. Therefore, according to this method of coupling the head unit, it is easy to sufficiently fix the head unit to the carriage.

Further, according to this method of coupling the head unit, the direction of the electrical coupling between the head unit and the carriage with the first connector and the second connector is orthogonal to the direction of the mechanical coupling between the head unit and the carriage with the first fixation mechanism and the second fixation mechanism. Accordingly, even when the crimping force for fixing the head unit becomes somewhat excessive, the stress applied to the first connector and the second connector is not large, and therefore, the possibility that the first connector or the second connector is damaged is reduced.

In one aspect of the method of coupling the head unit,
the first fixation mechanism may include a first handle,
the second fixation mechanism may include a second handle,
a part of the head unit may be located between the first handle and the first carriage surface, and
another part of the head unit may be located between the second handle and the first carriage surface.

In one aspect of the method of coupling the head unit,
a shortest distance between the first handle and the first carriage surface may be shorter than a shortest distance between the second handle and the second carriage surface, and
a shortest distance between the first handle and the first carriage surface may be longer than a shortest distance between the second handle and the first carriage surface.

In one aspect of the method of coupling the head unit,
the head unit may include
a tube coupling section to be coupled to a tube supplied with the liquid, and
a housing configured to house the drive board and provided with the second connector,
the housing may include
a first surface, and
a second surface opposite to the first surface,
the second connector may be provided to the first surface, and
the tube coupling section may be provided to the second surface.

In one aspect of the method of coupling the head unit,
the head unit may include
a grip to be used when the head unit is moved in a direction of getting closer to the second carriage surface to be mounted on the carriage.

In one aspect of the method of coupling the head unit,
the head unit may include
a roller to be used when the head unit is moved in a direction of getting closer to the second carriage surface to be mounted on the carriage.

What is claimed is:

1. A liquid ejection apparatus comprising:
a carriage;
a head unit which is mounted on the carriage and is configured to eject a liquid to a medium; and
a power supply circuit configured to supply power to the head unit, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

2. The liquid ejection apparatus according to claim 1, wherein
the first fixation mechanism includes a first handle,
the second fixation mechanism includes a second handle,
a part of the head unit is located between the first handle and the first carriage surface, and
another part of the head unit is located between the second handle and the first carriage surface.

3. The liquid ejection apparatus according to claim 2, wherein
a shortest distance between the first handle and the second carriage surface is shorter than a shortest distance between the second handle and the second carriage surface, and
a shortest distance between the first handle and the first carriage surface is longer than a shortest distance between the second handle and the first carriage surface.

4. The liquid ejection apparatus according to claim 1, wherein
the head unit includes
a tube coupling section to be coupled to a tube supplied with the liquid, and
a housing configured to house the drive board and provided with the second connector,
the housing includes
a first surface, and
a second surface opposite to the first surface,
the second connector is provided to the first surface, and
the tube coupling section is provided to the second surface.

5. The liquid ejection apparatus according to claim 1, wherein
the head unit includes
a grip to be used when the head unit is moved in a direction of getting closer to the second carriage surface to be mounted on the carriage.

6. The liquid ejection apparatus according to claim 1, wherein
the head unit includes
a roller to be used when the head unit is moved in a direction of getting closer to the second carriage surface to be mounted on the carriage.

7. A head unit which is supplied with power from a power supply circuit, mounted on a carriage, and configured to eject a liquid to a medium, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit comprising:
a drive board including a drive signal generation circuit configured to generate a drive signal based on the power supply voltage;
a second connector configured to supply the power supply voltage to the drive board via the first connector;
a liquid ejection head including a piezoelectric element configured to eject the liquid by application of the drive signal; and
a second fixation mechanism configured to fix the head unit to the carriage, wherein,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism.

8. The head unit according to claim 7, wherein
the first fixation mechanism includes a first handle,
the second fixation mechanism includes a second handle,
a part of the head unit is located between the first handle and the first carriage surface, and
another part of the head unit is located between the second handle and the first carriage surface.

9. The head unit according to claim 8, wherein
a shortest distance between the first handle and the second carriage surface is shorter than a shortest distance between the second handle and the second carriage surface, and
a shortest distance between the first handle and the first carriage surface is longer than a shortest distance between the second handle and the first carriage surface.

10. The head unit according to claim 7, further comprising:
a tube coupling section to be coupled to a tube supplied with the liquid; and
a housing configured to house the drive board and provided with the second connector, wherein
the housing includes
a first surface, and
a second surface opposite to the first surface,
the second connector is provided to the first surface, and
the tube coupling section is provided to the second surface.

11. The head unit according to claim 7, further comprising:
a grip to be used when the head unit is moved in a direction of getting closer to the second carriage surface to be mounted on the carriage.

12. The head unit according to claim 7, further comprising:
a roller to be used when the head unit is moved in a direction of getting closer to the second carriage surface to be mounted on the carriage.

13. A method of coupling a head unit, which is supplied with power from a power supply circuit and configured to eject a liquid to a medium, to a carriage, wherein
the carriage includes
a first carriage surface on which the head unit is mounted,
a first connector to which a power supply voltage supplied from the power supply circuit propagates,
a second carriage surface which crosses the first carriage surface and is provided with the first connector, and
a first fixation mechanism configured to fix the head unit to the carriage,
the head unit includes
a drive board including a drive signal generation circuit configured to generate a drive signal based on the power supply voltage,
a second connector configured to supply the power supply voltage to the drive board via the first connector,
a liquid ejection head including a piezoelectric element configured to eject the liquid by application of the drive signal, and
a second fixation mechanism configured to fix the head unit to the carriage,
when defining a normal direction of the first carriage surface as a first direction, a normal direction of the second carriage surface as a second direction, and a direction orthogonal to the first direction and the second direction as a third direction,
the first fixation mechanism and the second fixation mechanism are configured to fix the head unit in the first direction,
the first connector and the second connector are fitted to each other in the second direction, and
when viewed from the third direction, the first connector and the second connector are located between the first fixation mechanism and the second fixation mechanism,
the method comprising:
mounting the head unit on the carriage so that a surface provided with the liquid ejection head of the head unit and the first carriage surface are parallel to each other;
fitting the first connector and the second connector to each other while keeping a state in which the surface provided with the liquid ejection head and the first carriage surface are parallel to each other; and
operating the first fixation mechanism and the second fixation mechanism to fix the head unit to the carriage.

14. The method of coupling the head unit according to claim 13, wherein
the first fixation mechanism includes a first handle,
the second fixation mechanism includes a second handle,
a part of the head unit is located between the first handle and the first carriage surface, and
another part of the head unit is located between the second handle and the first carriage surface.

15. The method of coupling the head unit according to claim 14, wherein
a shortest distance between the first handle and the second carriage surface is shorter than a shortest distance between the second handle and the second carriage surface, and
a shortest distance between the first handle and the first carriage surface is longer than a shortest distance between the second handle and the first carriage surface.

16. The method of coupling the head unit according to claim 13, wherein
the head unit includes
a tube coupling section to be coupled to a tube supplied with the liquid, and
a housing configured to house the drive board and provided with the second connector,
the housing includes
a first surface, and
a second surface opposite to the first surface,
the second connector is provided to the first surface, and
the tube coupling section is provided to the second surface.

17. The method of coupling the head unit according to claim 13, wherein
the head unit includes
a grip to be used when the head unit is moved in a direction of getting closer to the second carriage surface to be mounted on the carriage.

18. The method of coupling the head unit according to claim 13, wherein
the head unit includes
a roller to be used when the head unit is moved in a direction of getting closer to the second carriage surface to be mounted on the carriage.
